(19) United States
(12) Patent Application Publication
(10) Pub. No.: US 2007/0110986 A1
(43) Pub. Date: May 17, 2007

(54) Insulated packaging material

(75) Inventor: Jack Mitchell Eisenberg, Buffalo Grove, IL (US)

Correspondence Address: DARBY & DARBY P.C., P. O. BOX 5257, NEW YORK, NY, 10150-5257, US

(73) Assignee: Nielsen & Bainbridge LLC, Paramus, NJ (US)

(21) Appl. No.: 11/542,621

(22) Filed: Oct. 2, 2006

Related U.S. Application Data
(60) Provisional application No. 60/723,373, filed on Oct. 3, 2005.

(51) Int. Cl. B32B 3/26; B32B 9/00

(52) U.S. Cl. 428/304.4; 428/318.4

(57) ABSTRACT

A packaging material for making insulated containers, comprises a foam core and a radiant barrier layer laminated to at least one side of the foam core. Preferably, the radiant barrier layer comprises a plastic film metallized on at least one side bonded to a paper substrate. The paper substrate of the radiant barrier layer may be bonded to the foam core by the application of heat and pressure.

### CROSS-REFERENCE TO RELATED APPLICATION

This application claims priority to U.S. Provisional Patent Application Ser. No. 60/723,373 filed on Oct. 3, 2005 and incorporated herein, by reference, in its entirety.

### FIELD OF THE INVENTION

This invention relates to an insulated packaging material of particular utility where maintenance of the temperature of the product is desirable.

Material manufactured in accordance with the invention is relatively thin yet is strong and provides substantial insulation. The material can be used for many purposes including, but not limited to, shipping food products where it is desired to maintain the temperature of the food.

### BACKGROUND OF THE INVENTION

Insulated packaging is used to transport food and other products which are temperature sensitive. Various different materials are used for this purpose, including plastic foam and corrugated cardboard. Plastic foam has good insulating values, but it is relatively thick and requires a large amount of space for storage. Moreover, plastic foam materials are difficult if not impossible to form into a container using standard box-making equipment. Corrugated cardboard can be shipped flat and made into containers using standard equipment, but its insulation values are relatively low.

The main object of this invention is to provide an improved insulating material from which insulated containers can be manufactured.

A more specific object of the invention is to provide a relatively thin material with high insulating properties which can be made into a container using standard box-making equipment.

A further object of the invention is to provide an insulating material for containers which can be shipped flat and which takes up less space than other materials which provide comparable insulating properties.

A further object of the invention is to provide an insulated package which requires relatively little space for storage, is easy to assemble and is attractive in appearance.

### SUMMARY OF THE INVENTION

Briefly, in accordance with the invention, an insulating packaging material comprises a plastic foam core having a radiant barrier material laminated to at least one side. In the preferred embodiment, the radiant barrier material comprises a plastic film metallized on both sides, thermally bonded to the foam core. Preferably, a radiant barrier material is bonded to both sides of the foam core.

### DESCRIPTION OF THE DRAWINGS

FIG. 1 is a side view showing the insulating material in accordance with a preferred embodiment of the invention; and

FIG. 2 is a detailed sectional view of a preferred embodiment of the invention showing the preferred construction of the barrier layer materials.

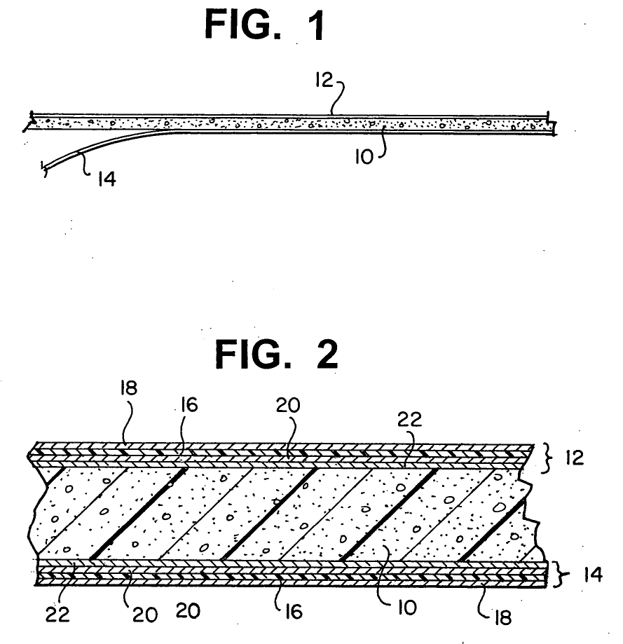

### DETAILED DESCRIPTION

The packaging material according to the invention comprises a foam center or core 10 having radiant barrier layers 12 and 14 laminated to opposite sides. The layers 12 and 14 may be identical. Each comprises a polyester film 16 having metallized layers 18 and 20 deposited on opposite sides of the film. Such films are commercially available (e.g. from Graphic Packaging International); in the preferred embodiment, the metallized layers 18 and 20 comprise aluminum. The metallized film 16 is laminated to a paper substrate 22 which provides added strength to the material. In the preferred embodiment, the metallized film 16 is laminated to the paper substrate 22 by means of a conventional adhesive. Other bonding agents such as polyethylene can also be used. The combination of the paper substrate 22 and the metallized film 16 thus comprise the radiant barrier layers 12 and 14.

In the preferred embodiment, the radiant barrier layers 12 and 14 are laminated to the foam core 10 simultaneously by the application of heat and pressure. The heat applied is sufficient to bond the fibers of the paper substrate 22 to the foam. This creates a strong and moisture resistant material, although adhesives and other bonding agents could also be used to bond the radiant barrier layers to the foam.

The invention provides insulation values comparable to materials which are much thicker. This results in substantial space savings in both the storage and distribution facilities. By way of example, a board manufactured in accordance with the preferred embodiment of the invention and 3/16″ thick, when tested over a twenty-four hour time period, proved to be 95% as effective in terms of its insulating properties as a commercially available foam configuration which was 1.5″ thick.

In addition to its space saving advantage, a board manufactured in accordance with the invention can be processed using standard box making equipment. It can be shipped flat and formed in the same way as a corrugated box. It is easy to clean and can be reused many times.

Numerous modifications of the invention are contemplated. In a preferred embodiment, a closed cell polystyrene foam is used but other types of foam can be used as well. In a commercial embodiment, the paper substrate 22 was 35 lb. liner board. The radiant barrier material can be laminated to only one side of the foam core 10 in which case a standard paper or liner board material can be bonded to the opposite side. It is beneficial to use a radiant barrier material which includes a film that has been metallized on both sides but the benefits of the invention can be obtained even if the film is metallized on only one side. In place of the metallized film, a metallic foil, e.g., aluminum, may be used to form the radiant barrier material. A coating may be applied to the radiant barrier material to assist in printing or possibly enhance the ability to bond the material to another container. The invention contemplates a wide range of thickness. For practical purposes, a total thickness between ⅛ and ½ inch is preferred.

While the invention has been particularly shown and described with reference to preferred embodiments thereof, it will be understood by those skilled in the art that various changes in form and details may be made therein without departing from the spirit and scope of the invention.

1. A packaging material for making insulated containers, comprising a foam core and a radiant barrier layer laminated to at least one side of the foam core, said radiant barrier layer comprising a plastic film metallized on at least one side.

2. A packaging material according to claim 1, wherein a radiant barrier layer is laminated to both sides of the foam core.

3. A packaging material according to claim 1, wherein the radiant barrier layer comprises a plastic film metallized on at least one side and bonded to a paper substrate.

4. A packaging material according to claim 1, wherein the radiant barrier layer comprises a plastic film having a metallized layer on both sides thereof to form a metallized film, said metallized film being bonded to a paper substrate.

5. A packaging material according to claim 4, wherein the paper substrate of the radiant barrier layer is bonded to said foam core by the application of heat and pressure.

6. A packaging material for making insulated containers, comprising a foam core and a radiant barrier layer laminated to both sides of the foam core, each said radiant barrier layer comprising a plastic film metallized on at least one side.

7. A packaging material according to claim 6, wherein each radiant barrier layer comprises a plastic film metallized on at least one side and bonded to a paper substrate.

8. A packaging material according to claim 6, wherein each radiant barrier layer comprises a plastic film having a metallized layer on both sides thereof to form a metallized film, said metallized film being bonded to a paper substrate.

9. A packaging material according to claim 8, wherein the paper substrate of the radiant barrier layer is bonded to said foam core by the application of heat and pressure.
